(19) United States
(12) Patent Application Publication
(10) Pub. No.: US 2019/0201938 A1
(43) Pub. Date: Jul. 4, 2019

(54) TOOL, PREFERABLY FOR FLASH-TRIMMING AND/OR CLEANING PLASTIC COMPONENTS

(71) Applicant: KRAUSSMAFFEI TECHNOLOGIES GMBH, München (DE)

(72) Inventor: Sebastian EICKENS, Kevelaer (DE)

(21) Appl. No.: 16/331,036

(22) PCT Filed: Sep. 12, 2017
(86) PCT No.: PCT/EP2017/072797

§ 371 Date: Mar. 6, 2019

(30) Foreign Application Priority Data
Sep. 19, 2016 (DE) 10 2016 117 603.6

(51) Int. Cl. B08B 1/04; B26D 1/36; B26D 1/553

(52) U.S. Cl. CPC B08B 1/04; B23B 51/101; B26D 1/553; B26D 1/36

(57) ABSTRACT

A tool for flash-trimming and/or cleaning a component, comprising a shaft and a processing element mounted on the shaft such that it can be removed, the processing element being designed as a flexible cord and being received on the shaft such that, in an operational state, it bulges radially outwards in at least some sections as the rotational speed of the shaft increases; the invention also relates to a processing system along with this tool

The invention relates to a tool for flash-trimming and/or cleaning a component, i.e. a flash-trimming and/or cleaning tool/a device for flash-trimming and/or cleaning components, preferably plastic components, alternatively, however, also metallic components, wood-, ceramic- or concrete components, comprising a shaft and a processing element mounted on said shaft such that it can be removed. The tool can therefore be used for flash-trimming components and/or for cleaning materials adhering to component edges and surfaces.

Basically various flash-trimming methods are already known from the prior art. In this context, for example, DE 10 2007 054 521 A1 discloses a flash-trimming tool with a carrier configured as a shaft. A manual flash-trimming of components with abrading bodies or blades or similar processing elements is also basically known.

The flash-trimming methods hitherto have the disadvantage that frequently no stable process management is possible. In addition, a relatively high deployment of staff can be necessary, which also entails a long cycle time. Furthermore, the quality of the flash-trimming fluctuates relatively intensively, so that a high reject rate can arise. Moreover, with the manual and mechanical flash-trimming methods known hitherto, frequently a relatively high load of the component base body occurs, and consequently a relatively intensive removal of material on the component base body (good part).

It is therefore the object of the present invention to eliminate these disadvantages known from the prior art and in particular to provide a tool which is to enable a conservative and reproducible flash-trimming/cleaning.

This is solved according to the invention in that the processing element is designed as a flexible/yielding cord and is received on the shaft such that, in an operational state, it bulges radially outwards in at least some sections as the rotational speed of the shaft increases.

Thereby, the processing element is embodied as a cord/striking cord, which is adapted, in a particularly precise manner by means of various parameters of the process management, to a weak point separation of a flash or of a material adhesion on the attachment point to the component base body. A compensation of the tolerances of the tool drive, for example by an automated moving device, and of the tolerances of the components, is guaranteed through the flexibility of this cord. The tool can be precisely adjusted and operated both stationary and also on the automated moving device. Therefore, an automated application with an automated moving device is particularly effective.

In other words, the flash-trimming/cleaning tool according to the invention serves preferably for flash-trimming/cleaning of plastic components in all known specifications (for example as a foam, injection-moulded, cast, extruded component, etc.). By means of a spindle drive, for example, the flash-trimming/cleaning tool is set in rotation during operation, and the flash/flake/flint or the adhesion of material is removed with geometrically unspecified or specified cutting/striking bodies in the form of the cord. Through a repeated striking pulse (dependent on the rotational speed of the tool and variant of the tool and dependent on the feed speed of the automated moving device along the processing edge or processing surface), the flash is separated at its shear plane to the main body. As the striking energy requirement for separating the flash for separating the flash is very low relative to the striking energy requirement for damaging the surface of the main body, the process is adjustable by means of the cord, so that damage to the main body is prevented. Different cases of application require different striking energies, wherein this takes place easily through modification of the cord with regard to mass, material, inherent rigidity and geometric shape and/or through modification of the rotational speed, circumferential speed and/or through modification of the prestressing of the cord and of the contact pressure onto the component base body.

Further advantageous embodiments are claimed in the subclaims and are explained in further detail below.

When the processing element is received on the shaft in a torque-proof manner, or fixed, at two receiving positions arranged spaced apart along the rotation axis of the shaft, the tool is able to be implemented skillfully for different component dimensions depending on the length of the processing element.

When a receiving notch is provided at a first receiving position of the shaft, in which the cord/processing element projects and/or is guided in a displaceable manner, the processing element is able to be mounted particularly easily on the shaft.

In this context, it is also advantageous when the receiving notch is provided on a face side of the shaft, preferably at an upper end of the shaft, so that the cord is also exposed towards a face side of the shaft. The geometric characteristics of the cord, with cooperation of the rotation, then enable the formation of a cutting body in the form of the processing element. When the processing element/cord projects by a certain extent out from the receiving notch, the cord is embodied particularly effectively as a cutting body.

Alternatively hereto, however, it is also possible to form the first receiving position as a through-hole, preferably a through-bore, which runs transversely, further preferably perpendicularly, to a rotation axis of the shaft, wherein the processing element then in turn projects into this through-hole and/or is directed displaceably in the latter. Thereby, also, the tool can be constructed so as to be particularly robust.

When the processing element is fastened to the shaft at a second receiving position arranged at a distance from the first receiving position, the processing element is secured particularly skilfully in its position relative to the shaft. The operational reliability and the process reliability are thereby further improved.

The second receiving position is advantageously likewise embodied as a through-hole, preferably a through-bore, which runs transversely, further preferably perpendicularly, to the rotation axis of the shaft.

When the processing element is running freely between the receiving positions, i.e. running spaced apart from the shaft, the structure of the tool is further simplified.

In this context, it is particularly expedient if the processing element is mounted on the shaft in the manner of a loop. Thereby, the loop shape and the flexibility of the cord can be influenced by the course of guidance of the cord. The loop shape is, furthermore, critical for accessibility on the component.

When several, preferably two, processing elements are connected to the shaft, the shape of the tool is able to be adjusted even more flexibly.

It is also advantageous if the processing element is connected or fixed at at least one end to a supporting arm extending transversely to the rotation axis of the shaft. Thereby, flashes or adhesions with a relatively large diameter can also be removed.

Furthermore, it is advantageous if with the use of two processing elements respectively one end of the respective processing element is clamped on a supporting arm. Thereby, the tool is used particularly skillfully for the flash-trimming and/or cleaning of large diameters.

When the processing element is held in a prestressed manner on the shaft by means of a spring element, through the spring pre-load the course/arrangement of the processing element can be adjusted in a skilful manner depending on the rotational speed.

In addition, it is advantageous if a penetrator, such as a mandrel tip, is mounted on the shaft, preferably on a face-side end/face-side of the shaft. Therefore, the discharge of the waste products which are forming is facilitated, and the entry of the tool into a closed flake/flint/flash skin is made possible.

When a removing element, such as a flash-trimming brush, an abrading body, a polishing body, a milling body or a drilling body is mounted on the shaft, preferably on a face-side end/face side of the shaft, the tool is able to be used in an even more versatile manner. Instead of the removing element, it is also possible to provide a further cleaning element on the face-side end/face side of the shaft, wherein the cleaning element is preferably embodied as a cleaning brush.

Furthermore, the invention relates to a processing system with a tool according to at least one of the previously described embodiments and with a processing machine receiving the tool, such as an automated moving device, a robot (e.g. an articulated-arm robot) or a CNC machine. Thereby, a particularly precise flash-trimming or respectively cleaning method is implemented.

The invention is now explained in further detail below with the aid of figures, in which context also various example embodiments are described.

There are shown:

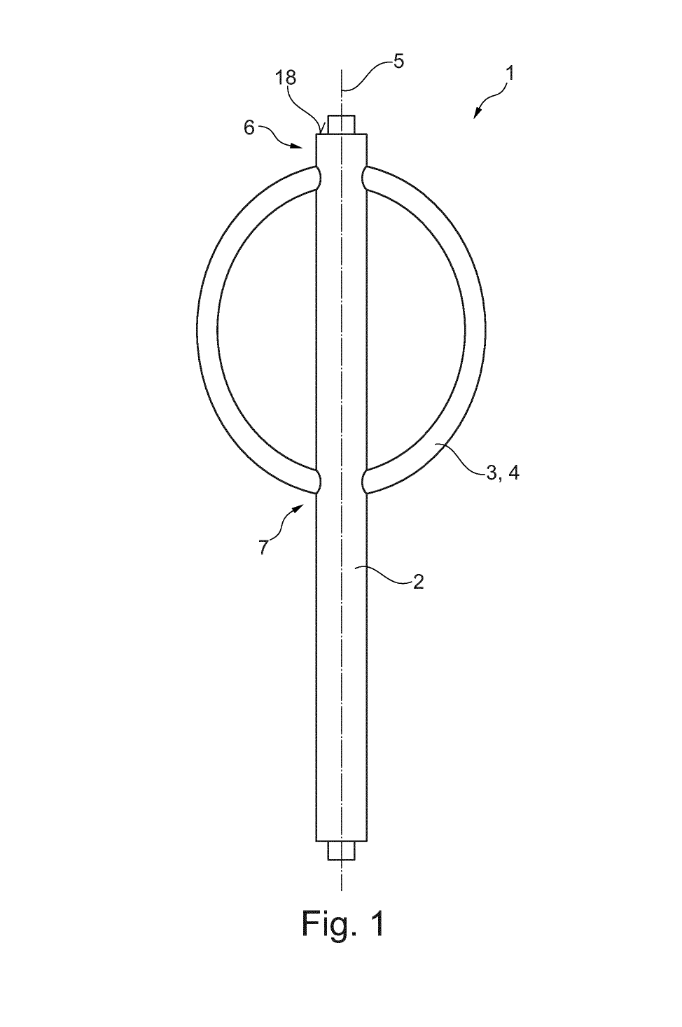

FIG. 1 a top view onto a tool according to the invention for cleaning and/or flash-trimming according to a first example embodiment, wherein a processing element, configured as a cord, is received in a loop-shaped manner on a shaft of the tool,

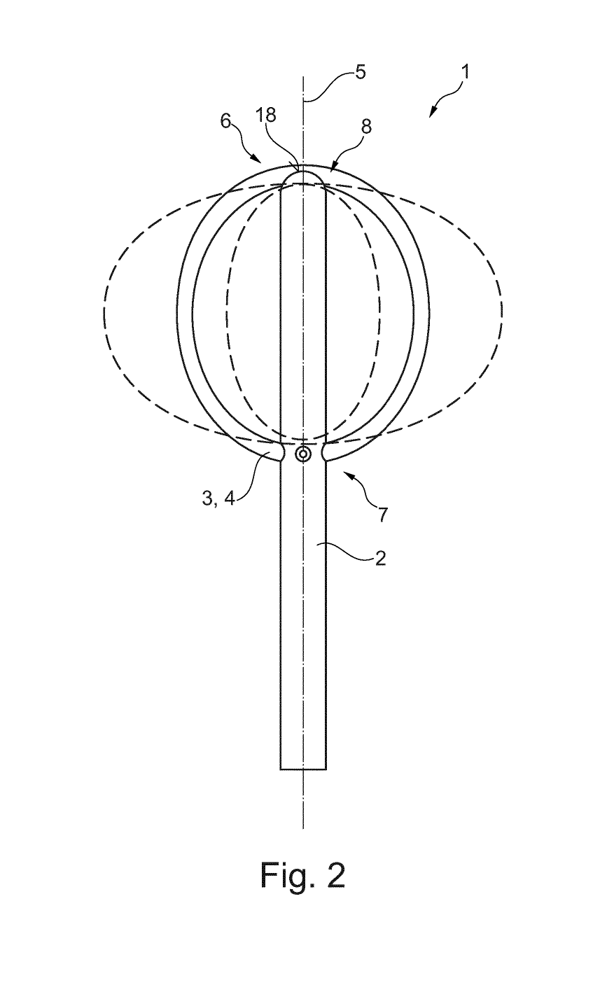

FIG. 2 a top view onto a tool according to the invention according to a second example embodiment, wherein the processing element is received and guided on a receiving notch of the shaft, arranged on the face side, along its extent transversely to the shaft,

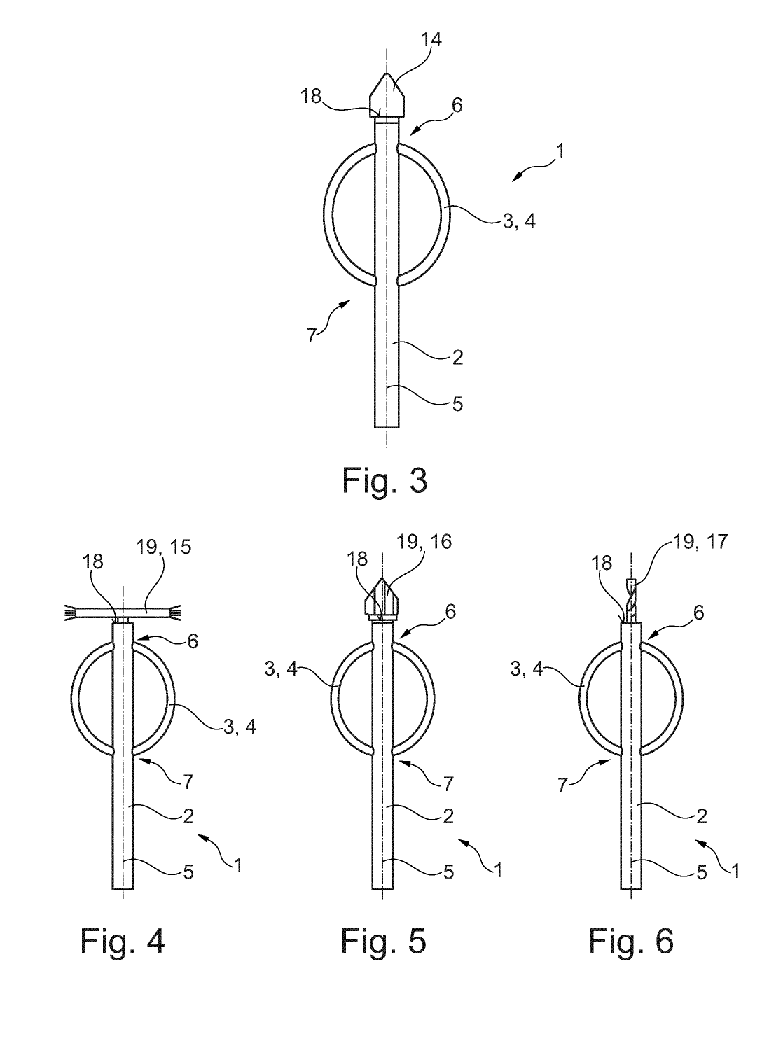

FIG. 3 a top view onto a tool according to the invention according to a third example embodiment, wherein the tool is constructed in a similar manner to the tool of FIG. 1, but is now provided with an additional mandrel tip,

FIG. 4 a top view onto a tool according to the invention according to a fourth example embodiment, wherein the tool is constructed in a similar manner to the tool of FIG. 1, but is now provided with an additional flash-trimming brush,

FIG. 5 a top view onto a tool according to the invention according to a fifth example embodiment wherein the tool is constructed in a similar manner to the tool of FIG. 1, but is now provided with an additional abrading body,

FIG. 6 a top view onto a tool according to the invention according to a sixth example embodiment, wherein the tool is constructed in a similar manner to the tool of FIG. 1, but is now provided with an additional milling body,

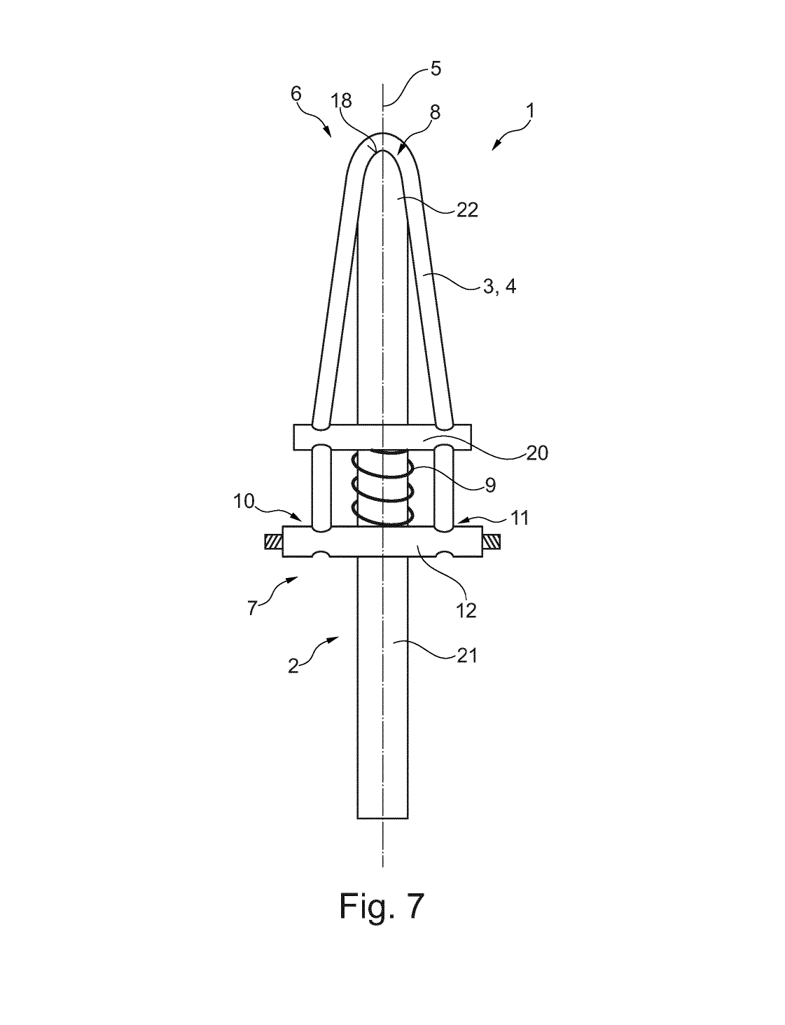

FIG. 7 a top view onto a tool according to the invention according to a seventh example embodiment, the processing element of which, in the form of a cord, is arranged in a prestressed manner on the shaft by means of a spring element, and

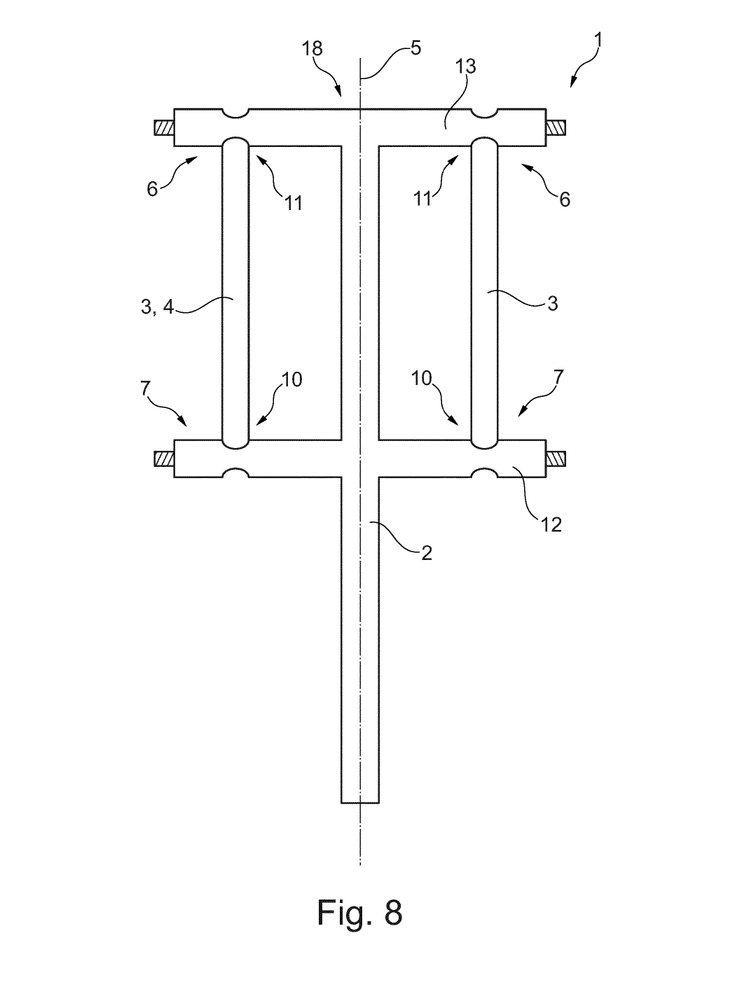

FIG. 8 a top view onto a tool according to the invention according to an eighth example embodiment, wherein with the shaft two supporting arms are formed, between which respectively two processing elements are clamped.

The figures are merely diagrammatic in nature and serve exclusively for an understanding of the invention. The same elements are provided with the same reference numbers. The various example embodiments can also be combined freely with one another in their specification.

In FIG. 1 a tool 1 according to the invention for flash-trimming and cleaning components according to a preferred first example embodiment is illustrated. The tool 1 is therefore also designated or respectively used as a flash-trimming/cleaning tool or flash-trimming and/or cleaning tool. The tool 1 has a longitudinally extending shaft 2. A longitudinal axis of the shaft 2 forms, at the same time, a rotation axis about which the shaft 2 rotates in an operational state of the tool 1. In addition, the tool 1 has a processing element 3, formed for the flash-trimming and/or cleaning. The processing element 3 is received/mounted on the shaft 2 in a torque-proof manner.

The processing element 3 consists of a flexible/yielding material and is formed as a cord 4. The processing element 3 is therefore formed directly by the flexible cord. The cord 4 is flexible such that it (elastically) deforms/bends/bulges depending on a rotational speed of the shaft 2 in the operational state. The cord 4 is mounted on the shaft 2 in a loop-like manner/as a loop.

To receive the cord 4 on the shaft 2, as can be seen furthermore, it is coupled to the shaft 2/held/received on the shaft 2 in a torque-proof manner at two receiving positions 6 and 7 arranged spaced apart from one another along the rotation axis 5. At a first receiving position 6, the cord 4 is guided through an accurately fitting through-hole (preferably clearance fit) and is thereby connected to the shaft 2 in a torque-proof manner. At this first receiving position 6/in the through-hole of the first receiving position 6, the cord 4 is preferably guided in a displaceable manner. At a second receiving position 7, likewise an (accurately fitting (preferably by clearance fit)) through-hole is provided, into which the cord 4 again projects and is received in the shaft 2 in a torque-proof manner.

As a whole, the processing element 3 forms two part-circle-like/semicircle-like (i.e. part-/semi-elliptical) loops, which extend between the receiving positions 6 and 7 freely, i.e. spaced apart from the shaft 2. The two loops are arranged/formed here lying opposite in a plane relative to the shaft 2. By means of the side facing radially away from the shaft 2, the cord 4 is used during operation for flash-trimming and/or cleaning, i.e. the cord 4 removes, by means of its outer side, the flash or the adhesion on the component which is respectively to be flash-trimmed or cleaned. Here, the cord 4, depending on the rotation speed, strikes onto the flash which is to be removed or onto the adhesion which is to be removed, so that the latter is removed. Through the flexible configuration of the cord 4, in the operational state of the tool 1 the cord 4 bulges outwards from the shaft 2 in radial direction and therefore receives, during operation, a stable form, which is dependent on the rotational speed and therefore on the centrifugal force. The cord 2 therefore serves as a striking cord in the operational state.

The cord 4 is received at the receiving positions 6, 7 such that it is designed so as to be removable again with the shaft 2. Thereby, after a wear of the processing element 3, the latter can be exchanged particularly easily.

For the operation of the tool 1, by the rotating of the shaft 2, the processing element 3/the cord 4 is also set in rotation. Through the rotation and the centrifugal force connected therewith, the cord 4 is urged outwards from the shaft 2. This outwardly urged curvature of the cord 4 rolls/slides with its outer shape/outer side on the respective component base body. Preferably with the use of the tool 1 in a processing system, the feed movement is generated by an automated moving device, in which the tool 1 is then received and guided, for example along an edge/surface which is to be flash-trimmed/cleaned. Through the fact that the cord 4 has a defined flexibility and deformability, component tolerances and movement tolerances of the automated moving device are compensated—the cord 4 fits snugly against the component. Alternatively, the component can be guided around the tool 1, for example by means of an automated moving device. The rotating tool 1 can therefore stand still (i.e. be stationary), in order to only carry out the rotational movement. The tool 1 can therefore be operated in a stationary manner.

The cord 4 itself can consist of a metal material, of natural fibres, of a plastic, or of a ceramic material or combinations of these materials/substances. These materials/the cord 4 can also basically be provided or equipped with more or less abrasive surfaces or additions, according to the case of application.

In connection with FIG. 2, a second example embodiment of the tool 1 is illustrated which, however, is basically constructed in accordance with the tool 1 of the first example embodiment, for which reason only the differences are described below, for the sake of brevity.

In FIG. 2 the processing element 3/cord 4 is illustrated in two further alternative extents through two elliptical dashed lines. The cord 4 can be selected individually with regard to its length, according to the use of the tool 1 and of the component which is to be flash-trimmed. The dashed lines show alternative extents of the processing element 3, wherein these are always loop-like.

In addition, the first receiving position 6 is embodied slightly differently compared to the first example embodiment. A receiving notch 8 serves for this, which is introduced in a face side 18/face-side end of the shaft 2. The processing element 3/cord 4 extends through the receiving notch 8 and is guided displaceably in this receiving notch 8. At the same time, the receiving notch 8 is coordinated in its dimension to the processing element 3 such that the processing element 3 (in an accurately fitting manner (preferably by clearance fit)) is mounted in a torque-proof manner in the first receiving position 6. The depth of the receiving notch 8 is also coordinated with the processing element 3 such that the processing element 3 projects by a certain amount out from the face side 18 of the shaft 2, e.g. by half or one third of a diameter of the processing element 3. Therefore, this region of the processing element 3 can also be used for processing. Thereby, a particularly skilful notch fixing is carried out, so that the cord 4 is used on the tool 1 as a solution capable of immersion. In this variant, the cord 4 is therefore exposed at the first receiving position 6, so that the geometric characteristics of the cord 4 present a cutting body with cooperation of the rotation. At the second receiving position 7, the processing element 3 can be fixed on the shaft 2, for example by means of a screw or suchlike.

In connection with FIGS. 3 to 6, it is basically illustrated that the tool 1 of the first example embodiment is easily adaptable in further four example embodiments. In these example embodiments, various elements are mounted on the face side 18/on the shaft 2.

In FIG. 3 according to a third example embodiment of the tool 1, a mandrel tip 14 is mounted on the face side 18. The mandrel tip 14 forms a penetrator. The mandrel tip 14 is shaped and mounted on the shaft 2 so that it is aligned with its tip along the rotation axis and directed away from the shaft 2. Thereby, a penetrator in the form of the mandrel tip 14 is present, which enables the penetrating of flash material during operation.

Furthermore, it is also possible, in particular for an effective changeover processing and a multi-stage processing, to provide removing elements 19 according to the example embodiments of FIGS. 4 to 6 on the tool 1 of the first example embodiment.

In the fourth example embodiment according to FIG. 4, additionally or alternatively a flash-trimming brush 15, which alternatively also is embodied as a cleaning brush, is mounted on the face side 18/on the shaft 2, wherein the flash-trimming brush 15 has brushes on its radial outer side with respect to the rotation axis 5. As a variant, a flash-trimming/cleaning brush could alternatively also be used in axial direction (depending on the processing case), i.e. the individual brushes would then be aligned in axial direction.

According to the fifth example embodiment according to FIG. 5, it is also possible, instead of or in addition to the flash-trimming brush 15/cleaning brush, to mount an abrading body 16, alternatively also a polishing body, on the face side 18/on the shaft 2. This abrading/polishing body 16 has a radial and/or axial active surface facing away from the shaft 2, or active surfaces acting in other angular arrangements.

According to FIG. 6 according to a sixth example embodiment, it is also possible, alternatively or additionally, to mount a milling tool/a milling body 17 or a drill/drilling body on the face side 18/on the shaft 2.

The remaining structure and the remaining function of the tools 1 of the third to sixth example embodiments correspond substantially again to the structure and the function of the tool 1 of the first example embodiment.

In FIG. 7 a seventh example embodiment of the tool 1 is illustrated. This flash-trimming and/or cleaning tool 1, like the tool 1 of the first example embodiment, also has a shaft 2 on which again the processing element 3 is received in the form of the cord 4. The receiving of the processing element 3, however, is selected slightly differently from in the first example embodiment. The processing element 3 is again mounted on the shaft 2. With a first end 10 and with a second end 11 the processing element 3 is now fastened to a supporting arm 12 extending transversely to the shaft 2 (at the same axial height to the shaft 2). The supporting arm 12 is a torque-proof component of the shaft 2/connected to the shaft 2 in a torque-proof manner. The supporting arm 12 extends transversely, namely substantially perpendicularly, to the shaft 2/the rotation axis 5. Each end 10 and 11 of the processing element 3 is clamped in the supporting arm 12 on another side of the shaft 2. Therefore, the second receiving position 7 is formed here by the supporting arm 12. The processing element 3 extends from the respective end 10, 11 in longitudinal direction of the shaft 2 towards the first receiving position 6, which is formed here again on a face side of the shaft 2. The processing element 3 is laid around on the face side 18, so that ultimately a U-/V-shaped placing around of the cord 4 is achieved. For this, a notch can be provided on the face side 18.

Furthermore in this example embodiment the shaft 2 has multiple parts, namely two parts. The two shaft parts 21 and 22 are received/guided displaceably relative to one another. A first shaft part 21 is connected to the first supporting arm 12 in a displacement-proof manner. A second shaft part 22 has again the first receiving position 6 and is prestressed relative to the first shaft part 21 by means of a spring element 9, here a helical compression spring. In particular, the shaft parts 21 and 22 are prestressed relative to one another in the longitudinal direction of the shaft 2. This means that the face side 18, formed on the second shaft part 22, is prestressed relative to the first supporting arm 12, and therefore extends the processing element 13 in longitudinal direction of the shaft 2 with a predetermined prestressing force. Depending on the configuration of the spring element 9, during operation the processing element 3 is urged outwards/bulged outwards through the acting centrifugal force, wherein the centrifugal force acts here contrary to a spring force/prestressing force of the spring element 9.

In addition, the processing element 3 is guided on each side of the shaft 2 by means of a guiding arm 20 extending substantially parallel to the supporting arm 12. The guiding arm 20 is connected to the second shaft part 22 in a torque-proof manner.

A further example embodiment of a tool 1 is illustrated in FIG. 8. The tool 1 of this eighth example embodiment is again constructed similarly to the tool 1 of the first example embodiment. However, on this tool 1, not only a single processing element 3, but two processing elements 3 are present. Each processing element 3 is again embodied as a flexible cord 4. The processing elements 3 are now clamped between two supporting arms and 13 arranged spaced apart from one another in longitudinal direction of the shaft 2. The two supporting arms 12 and 13 extend again substantially perpendicularly/transversely to the rotation axis 5. The supporting arms 12, 13 also extend substantially parallel to one another. The processing elements 3 are clamped substantially straight between the supporting arms 12 and 13, viewed in the unstressed state/state of rest of the tool 1. In particular, the processing elements 3 extend substantially parallel to the rotation axis 5. In the operational state of the tool 1, each of the two processing elements 3 bulges with its portion running freely between the supporting arms 12 and 13 again in radial direction outwards/away from the shaft 2.

In other words, a basic structure of the tool 1 according to the invention always consists of a tool shaft 2, on which there is an upper fastening- and guiding point (first receiving/fastening position 6/upper striking cord fixing) and a lower fastening point (second receiving/fastening position 7/lower striking cord fixing). Between the two fastening points 6, 7 the striking cord 4 is laid and fastened in a loop course, parallel course or symmetry course. In the tool, the striking cord 4 is regarded as a wear component and can be exchanged at any time or can be modified for different applications. The tool 1 can be embodied, furthermore, as a modification with the upper guiding point 6 as notch fixing (receiving notch 8), in order to receive the striking cord 4. In further modifications, it is also possible to provide a mandrel tip or for changeover processing an additional processing tool such as a flash-trimming brush 15, an abrading body/polishing body 16 or a milling tool/drilling tool/drill (milling body 17). A further structural form of the tool 1 contains a prestressing spring element (spring element 9), which transfers the striking cord 4 into a basic rigidity and a press guidance in the upper notch guiding point 6. In addition, the prestressing spring element 9 enables for the striking cord 4 a flexibility even when the material is clamped onto the tool 1 without the formation of a loop. In the case of the loop shape, the prestressing spring element 9 enables a variable loop geometry depending on the rotational speed and the centrifugal force connected therewith. A further structural form of the tool 1 in the form of a flash-trimming harp (FIG. 8), which guides the striking cord 4 in parallel arrangement at a distance from the base body of the component, enables in rotation a substantially cylindrical tool geometry. The natural flexibility of the striking cord 4 also enables in this arrangement a snug fitting behaviour (bulging out) against the base body of the processing workpiece/component. This variant can also be embodied alternatively as a triangle with a central upper striking cord fixing 6 or with different geometries and also with a spring prestressing element. In addition, the tool 1 can guide one, two (generally), or more striking cords 4 on it. The tool 1 can be operated in a stationary manner or on an automated moving device or in another processing machine, such as a CNC milling machine.

The structural form according to the invention, which is adapted to the conditions such as drive unit and component geometry and is as far as possible integrated, offers the smallest possible interference contours and therefore enables a maximum utilization of the degrees of freedom and movement possibilities of the automated moving device which is used, in particular in the case of complex three-dimensional contour processing. The purpose of use for the plastic processing is also able to be expanded. Also, metallic materials, wood, ceramics and concrete can be flash-trimmed or cleaned of adhesions with this tool arrangement. Several fields of application exist for the tool 1. Both as a tool in CNC processing, and also as a tool attachment when processing with a 6-axis articulated arm robot or other automated moving device. The type of operation of this tool 1 can take place both in the same direction and also in counter direction.

### LIST OF REFERENCE NUMBERS

1 flash-trimming/cleaning tool
2 shaft
3 processing element
4 cord
5 rotation axis
6 first receiving position
7 second receiving position
9 receiving notch
9 spring element
10 first end
11 second end
12 first supporting arm
13 second supporting arm
14 mandrel tip
15 flash-trimming brush
16 abrading body
17 milling body
18 face side
19 removing element
20 guiding arm
21 first shaft part
22 second shaft part

What is claimed is:

1. A tool (1) for flash-trimming and/or cleaning a component, comprising a shaft (2) and a processing element (3) mounted on the shaft (2) such that it can be removed, wherein the processing element (3) is designed as a flexible cord (4) and is received on the shaft (2) such that, in an operational state, it bulges radially outwards in at least some sections as the rotational speed of the shaft (2) increases, and wherein the processing element (3) is fixed or received in a torque-proof manner on the shaft (2) at two receiving positions (6, 7) arranged spaced apart along a rotation axis (5) of the shaft (2), wherein the processing element (3) is mounted as a circulating loop on the shaft (2).

2. (canceled)

3. The tool (1) according to claim 1, wherein a receiving notch (8) is provided at a first receiving position (6), in which the processing element (3) projects and/or is guided in a displaceable manner.

4. (canceled)

5. The tool (1) according to claim 1, wherein the processing element (3) is held on the shaft (2) in a prestressed manner by means of a spring element (9).

6. The tool (1) according to claim 1, wherein several processing elements (3) are connected to the shaft (2).

7. The tool (1) according to claim 1, wherein the processing element (3) is fixed or connected at least one end (10, 11) to a supporting arm (12, 13) extending transversely to a rotation axis (5) of the shaft (2).

8. The tool (1) according to claim 1, wherein a penetrator, such as a mandrel tip (14), is mounted on the shaft (2).

9. The tool (1) according to claim 1, wherein a removing element (19), comprising at least one of a flash-trimming brush (15), an abrading body (16), a polishing body, a milling body (17), or a drilling body, is mounted on the shaft (2).

10. A processing system with the tool (1) according to claim 1 and with a processing machine receiving the tool (1), comprising an automated moving device or articulated arm robot.
